(19) United States
(12) Patent Application Publication
(10) Pub. No.: US 2010/0080116 A1
(43) Pub. Date: Apr. 1, 2010

(54) RE-ESTABLISHING A RADIO RESOURCE CONTROL CONNECTION WITH A NON-PREPARED BASE STATION

(75) Inventors: Parag A. Agashe, San Diego, CA (US); Osok Song, San Diego, CA (US); Nathan E. Tenny, Poway, CA (US); Fatih Ulupinar, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/567,046

(22) Filed: Sep. 25, 2009

Related U.S. Application Data
(60) Provisional application No. 61/101,095, filed on Sep. 29, 2008.

(51) Int. Cl. H04L 12/24; H04W 36/00

(52) U.S. Cl. 370/216; 370/331

(57) ABSTRACT

A method for establishing a radio resource control connection is disclosed. A wireless communication device may establish a radio resource control connection with a first base station. The wireless communication device may send a message to a second base station that requests re-establishment of the radio resource control connection. The wireless communication device may receive a message from the second base station that initiates setup of a new radio resource control connection.

### CROSS-REFERENCE TO RELATED APPLICATIONS

This application is related to and claims priority from U.S. Provisional Patent Application Ser. No. 61/101,095, filed Sep. 29, 2008, for “Connection Recovery in a Non-Prepared Cell,” with inventors Parag Agashe, Osok Song, Nathan Tenny and Fatih Ulupinar, which is incorporated herein by reference.

### TECHNICAL FIELD

The present disclosure relates generally to wireless communication systems. More specifically, the present disclosure relates to re-establishing a radio resource control (RRC) connection with a non-prepared base station.

### BACKGROUND

Wireless communication systems have become an important means by which many people worldwide have come to communicate. A wireless communication system may provide communication for a number of wireless communication devices, each of which may be serviced by a base station.

A wireless communication device is an electronic device that may be used for voice and/or data communication over a wireless communication system. A wireless communication device may alternatively be referred to as a mobile station, a user equipment, an access terminal, a subscriber station, a mobile terminal, a remote station, a user terminal, a terminal, a subscriber unit, a mobile device, etc. A wireless communication device may be a cellular phone, a smartphone, a personal digital assistant (PDA), a wireless modem, etc.

A base station is a fixed station (i.e., a wireless communication station that is installed at a fixed location) that communicates with wireless communication devices. A base station may alternatively be referred to as an access point, a Node B, an evolved Node B, or some other similar terminology.

A core network is the basic part of a wireless communication system that provides various services to customers who are connected to the core network by a radio access network. A radio access network typically includes multiple base stations and radio network controllers. A radio network controller (RNC) is responsible for controlling the base stations that are connected to it. For example, an RNC may carry out radio resource management, which may include functions such as admission control, packet scheduling, handover control, security functions, mobility management, etc.

The systems and methods disclosed herein relate generally to a radio resource control (RRC) connection that may exist between a wireless communication device and a radio access network. Radio resource control may include functions such as connection establishment and release, broadcast of system information, radio bearer establishment/reconfiguration and releases, paging notification and release, outer loop power control, etc. An RRC connection may be thought of as a number of parallel logical channels, each potentially capable of having a different quality of service (e.g., bit rate, block error rate, and so on). The logical entities used to associate radio resources for data transmission and reception with these logical channels are known as radio bearers. The systems and methods disclosed herein relate to the situation where a wireless communication device experiences radio link failure or another condition that requires a re-establishment of the RRC connection.

### BRIEF DESCRIPTION OF THE DRAWINGS

FIG. 1 illustrates a wireless communication system;

FIG. 2 illustrates a system for re-establishing an RRC connection with a non-prepared base station;

FIG. 3 illustrates a method for re-establishing an RRC connection with a non-prepared base station;

FIG. 4 illustrates means-plus-function blocks corresponding to the method of FIG. 3;

FIG. 5 illustrates a method for facilitating re-establishment of an RRC connection with a non-prepared base station;

FIG. 6 illustrates means-plus-function blocks corresponding to the method of FIG. 5;

FIG. 7 illustrates another method for re-establishing an RRC connection with a non-prepared base station;

FIG. 8 illustrates means-plus-function blocks corresponding to the method of FIG. 7;

FIG. 9 illustrates a method for facilitating re-establishment of an RRC connection with a non-prepared base station;

FIG. 10 illustrates means-plus-function blocks corresponding to the method of FIG. 9;

FIG. 11 illustrates a method for facilitating re-establishment of an RRC connection in an LTE system;

FIG. 12 illustrates another method for facilitating re-establishment of an RRC connection in an LTE system;

FIG. 13 illustrates certain components that may be included within a wireless communication device; and

FIG. 14 illustrates certain components that may be included within a base station.

### DETAILED DESCRIPTION

A method for establishing a radio resource control connection is disclosed. A wireless communication device establishes a radio resource control connection with a first base station. The wireless communication device sends a message to a second base station that requests re-establishment of the radio resource control connection. The wireless communication device receives a message from the second base station that initiates setup of a new radio resource control connection.

The wireless communication device may release existing bearers corresponding to the radio resource control connection in response to receiving the message. Alternatively, the wireless communication device may not release existing bearers corresponding to the radio resource control connection in response to receiving the message. In this case, the wireless communication device may receive a message from the second base station that initiates reconfiguration of the new radio resource control connection.

The message that requests re-establishment of the radio resource control connection may be sent to the second base station in response to detecting failure of a radio link with the first base station. Alternatively, the message that requests re-establishment of the radio resource control connection may be sent to the second base station in response to a decision to handover the wireless communication device from the first base station to the second base station.

The message that requests re-establishment of the radio resource control connection may be an RRCConnectionReestablishmentRequest message. The message that initiates setup of a new radio resource control connection may be an RRCConnectionSetup message.

A method for establishing a radio resource control connection is also disclosed. A base station receives a message from a wireless communication device that requests re-establishment of a radio resource control connection. The base station sends a message to the wireless communication device that initiates setup of a new radio resource control connection.

The base station may be a non-prepared base station that has not received radio resource control configuration information from a previous serving base station. The base station may trigger release of bearers at a core network. The bearers may correspond to a radio resource control connection between the wireless communication device and a previous serving base station. The base station may also establish new bearers for the new radio resource control connection. The base station may retrieve the context of the wireless communication device from a previous serving base station. The base station may send a message to the wireless communication device that initiates reconfiguration of the new radio resource control connection.

A wireless communication device is disclosed. The wireless communication device includes a processor, memory in electronic communication with the processor, and instructions stored in the memory. The instructions are executable by the processor to establish a radio resource control connection with a first base station. The instructions are also executable to send a message to a second base station that requests re-establishment of the radio resource control connection. The instructions are also executable to receive a message from the second base station that initiates setup of a new radio resource control connection.

A base station is disclosed. The base station includes a processor, memory in electronic communication with the processor, and instructions stored in the memory. The instructions are executable by the processor to receive a message from a wireless communication device that requests re-establishment of a radio resource control connection. The instructions are also executable to send a message to the wireless communication device that initiates setup of a new radio resource control connection.

A wireless communication device is disclosed. The wireless communication device includes means for establishing a radio resource control connection with a first base station. The wireless communication device also includes means for sending a message to a second base station that requests re-establishment of the radio resource control connection. The wireless communication device also includes means for receiving a message from the second base station that initiates setup of a new radio resource control connection.

A base station is disclosed. The base station includes means for receiving a message from a wireless communication device that requests re-establishment of a radio resource control connection. The base station also includes means for sending a message to the wireless communication device that initiates setup of a new radio resource control connection.

A computer-program product that includes a computer-readable medium having instructions thereon is disclosed. The instructions include code for establishing a radio resource control connection with a first base station. The instructions also include code for sending a message to a second base station that requests re-establishment of the radio resource control connection. The instructions further include code for receiving a message from the second base station that initiates setup of a new radio resource control connection.

A computer-program product that includes a computer-readable medium having instructions thereon is disclosed. The instructions include code for receiving a message from a wireless communication device that requests re-establishment of a radio resource control connection. The instructions also include code for sending a message to the wireless communication device that initiates setup of a new radio resource control connection.

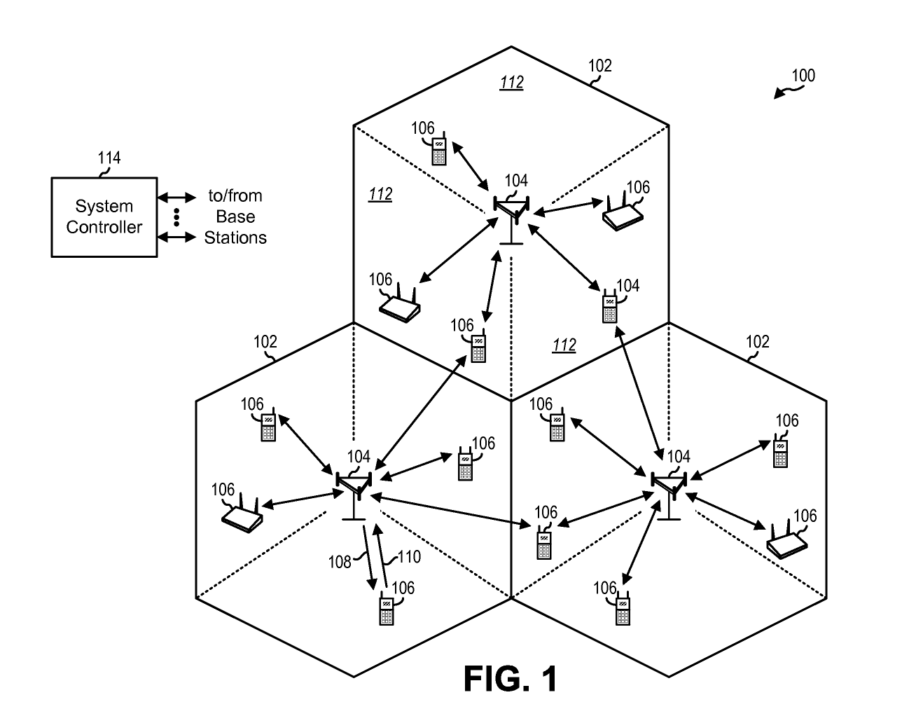

FIG. 1 illustrates a wireless communication system 100. The system 100 provides communication for multiple cells 102, with each cell 102 being serviced by a corresponding base station 104. As indicated above, a base station 104 is a fixed station that communicates with wireless communication devices 106. A base station 104 may alternatively be referred to as an access point, a Node B, an eNode B (“evolved Node B”), or some other similar terminology.

One or more wireless communication devices 106 may be dispersed within the system 100 over time. As indicated above, a wireless communication device 106 is an electronic device that may be used for voice and/or data communication over the wireless communication system 100. A wireless communication device 106 may alternatively be referred to as a mobile station, a user equipment, an access terminal, a subscriber station, a mobile terminal, a remote station, a user terminal, a terminal, a subscriber unit, a mobile device, etc. A wireless communication device 106 may be a cellular phone, a smartphone, a personal digital assistant (PDA), a wireless modem, or any other suitable device for communicating over the system 100.

A communication link that facilitates transmission from a base station 104 to a wireless communication device 106 may be referred to as a downlink 108, and a communication link that facilitates transmission from a wireless communication device 106 to a base station 104 may be referred to as an uplink 110. Alternatively, a downlink 108 may be referred to as a forward link or a forward channel, and an uplink 110 may be referred to as a reverse link or a reverse channel. In a frequency division duplex (FDD) system, a downlink 108 can utilize a different frequency band than that used by an uplink 110. In a time division duplex (TDD) system, a downlink 108 and an uplink 110 can utilize a common frequency band.

The resources of the wireless communication system 100 (e.g., bandwidth and transmit power) may be shared among multiple wireless communication devices 106. A variety of multiple access techniques are known, including code division multiple access (CDMA), time division multiple access (TDMA), frequency division multiple access (FDMA), orthogonal frequency division multiple access (OFDMA), single-carrier frequency division multiple access (SC-FDMA), and so forth.

To improve system capacity, a cell 102 may be partitioned into multiple sectors 112. Each sector 112 may be served by a respective base transceiver station (BTS). For a sectorized cell 102, the BTSs for all sectors 112 of that cell 102 are typically co-located within the base station 104 for the cell 102.

For a centralized architecture, a system controller 114 may couple to the base stations 104 and provide coordination and control for the base stations 104. The system controller 114 may be a single network entity or a collection of network entities. For a distributed architecture, base stations 104 may communicate with one another as needed.

As indicated above, the systems and methods disclosed herein relate generally to a radio resource control (RRC) connection that may exist between a wireless communication device and a radio access network. More specifically, the systems and methods disclosed herein relate to the situation where a wireless communication device experiences radio link failure (or another condition that requires a re-establishment of the RRC connection) and attempts to re-establish an RRC connection with a “non-prepared” base station, i.e., a base station that is different than the previous serving base station and that has not been prepared with RRC configuration information from the previous serving base station. The base station with which attempted RRC connection re-establishment occurs may be referred to as the “target” base station, and the previous serving base station as the “source” base station.

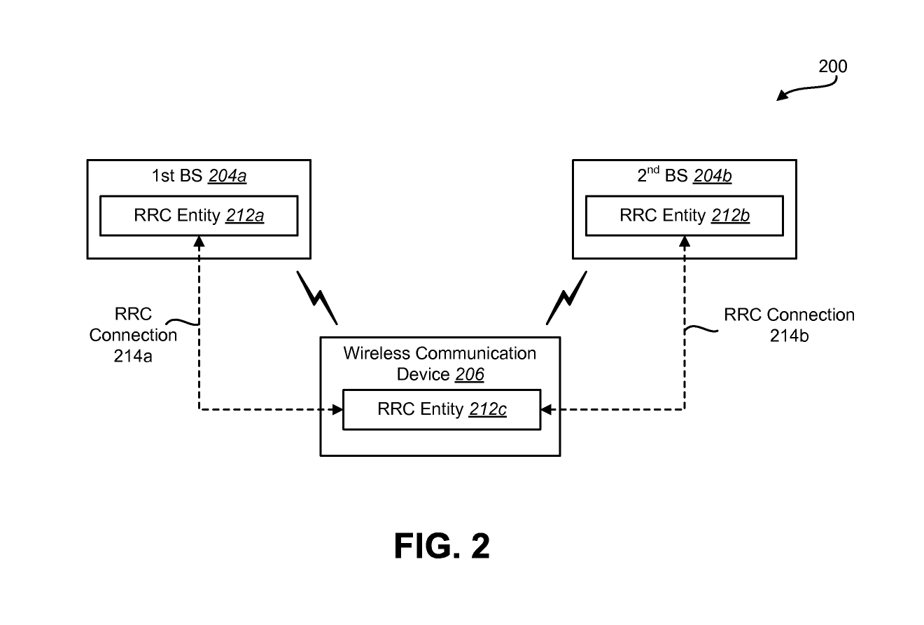

FIG. 2 illustrates a system 200 for re-establishing an RRC connection with a non-prepared base station. A wireless communication device 206 may initially be located within the coverage area of a first base station 204a. The wireless communication device 206 may establish an RRC connection 214a with the first base station 204a. This RRC connection 214a may be a logical connection that is established between an RRC entity 212a on the first base station 204a and an RRC entity 212c on the wireless communication device 206. The RRC entity 212a on the first base station 204a may work with the RRC entity 212c on the wireless communication device 206 to perform functions such as connection establishment and release, broadcast of system information, radio bearer establishment/reconfiguration and releases, paging notification and release, outer loop power control, etc.

At some point, the radio link between the wireless communication device 206 and the first base station 204a may fail. This may occur if the wireless communication device 206 moves outside of the coverage area of the first base station 204a and into the coverage area of the second base station 204b. In this situation, it may be desirable for the wireless communication device 206 to be able to re-establish an RRC connection. If the wireless communication device 206 is being served by the second base station 204b, then re-establishing an RRC connection may involve establishing an RRC connection 214b with the second base station 204b. This RRC connection 214b may be a logical connection between an RRC entity 212b on the second base station 204b and the RRC entity 212c on the wireless communication device 206. The second base station 204b may be a non-prepared base station 204b, i.e., it may not have been prepared with RRC configuration information from the previous serving base station 204a.

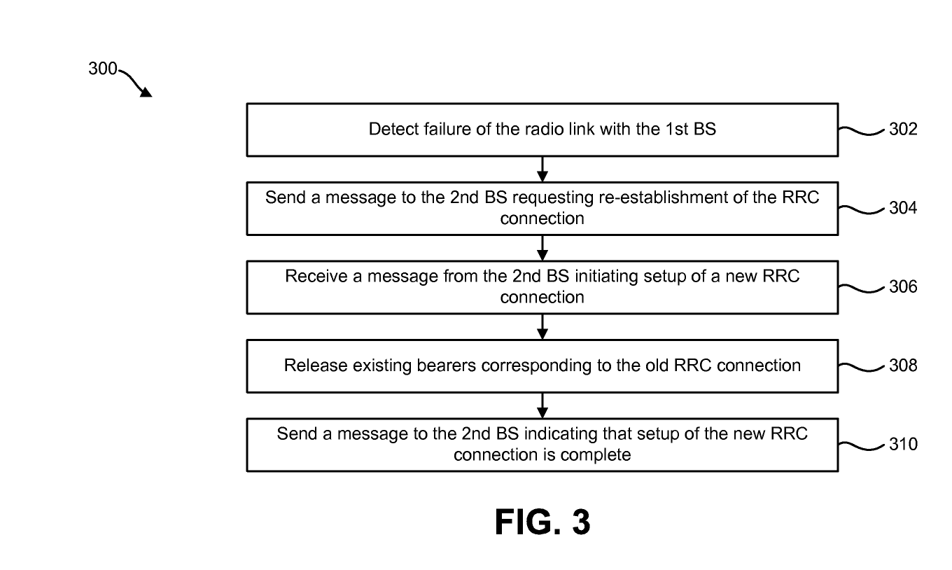

FIG. 3 illustrates a method 300 for re-establishing an RRC connection with a non-prepared base station 204b. The method 300 may be performed by a wireless communication device 206. In this method 300, it will be assumed that the wireless communication device 206 is initially being served by a first base station 204a, and that the wireless communication device 206 has established an RRC connection 214a with the first base station 204a.

At some point, the wireless communication device 206 may detect 302 failure of the radio link with the first base station 204a. This may occur, for example, if the wireless communication device 206 moves outside of the coverage area of the first base station 204a and into the coverage area of a second base station 204b.

In response to detecting 302 failure of the radio link with the first base station 204a, the wireless communication device 206 may send 304 a message to the second base station 204b requesting re-establishment of an RRC connection. As indicated above, the second base station 204b may be a non-prepared base station 204b, i.e., it may not have been prepared with RRC configuration information from the previous serving base station 204a.

The wireless communication device 206 may receive 306 a message from the second base station 204b initiating setup of a new RRC connection 214b. In response to receiving 306 this message, the wireless communication device 206 may release 308 existing radio bearers corresponding to the RRC connection 214a with the first base station 204a. When the setup of the new RRC connection 214b is complete, the wireless communication device 206 may send 310 a message to the second base station 204b indicating that setup of the new RRC connection 214b is complete.

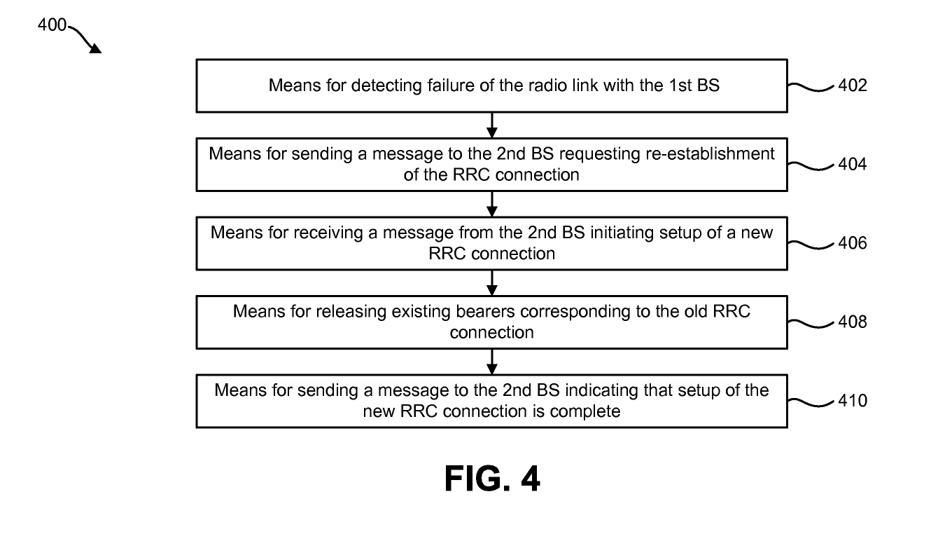

The method 300 of FIG. 3 described above may be performed by various hardware and/or software component(s) and/or module(s) corresponding to the means-plus-function blocks 400 illustrated in FIG. 4. In other words, blocks 302 through 310 illustrated in FIG. 3 correspond to means-plus-function blocks 402 through 410 illustrated in FIG. 4.

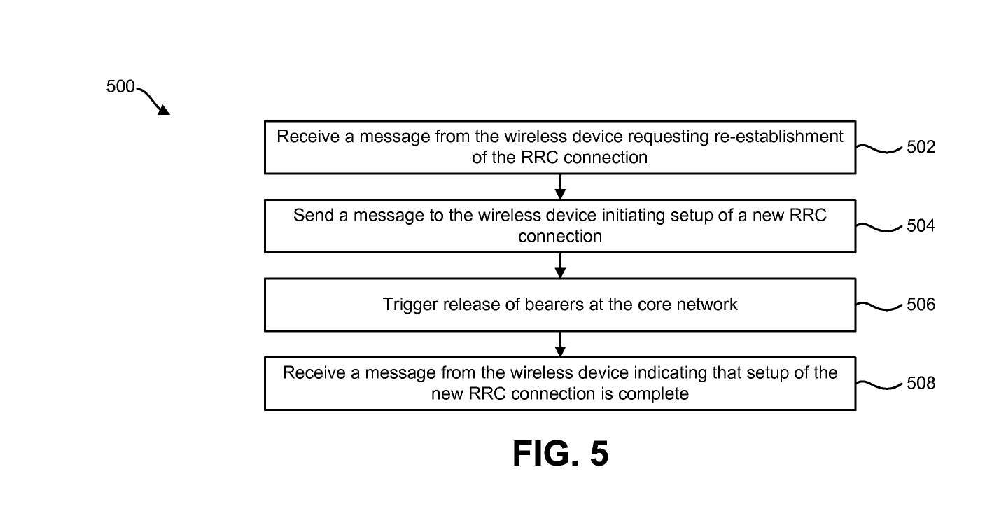

FIG. 5 illustrates a method 500 for facilitating re-establishment of an RRC connection with a non-prepared base station 204b. The method 300 may be performed by a non-prepared base station 204b.

The base station 204b may receive 502 a message from a wireless communication device 206 requesting re-establishment of an RRC connection. In response to receiving 502 this message, the base station 204b may send 504 a message to the wireless communication device 206 initiating setup of a new RRC connection 214b. The base station 204b may trigger 506 the release of radio bearers associated with the old RRC connection 214a at the core network. This may involve sending one or more messages to the core network notifying the core network that the radio bearers associated with the old RRC connection 214a should be released. When the setup of the new RRC connection 214b is complete, the base station 204b may receive 508 a message from the wireless communication device 206 indicating that the setup of the new RRC connection 214b is complete.

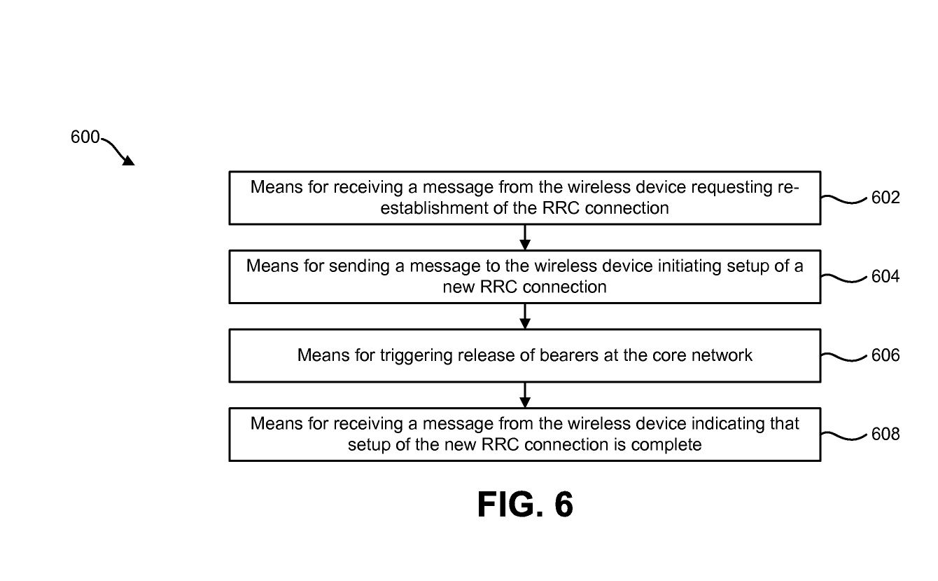

The method 500 of FIG. 5 described above may be performed by various hardware and/or software component(s) and/or module(s) corresponding to the means-plus-function blocks 600 illustrated in FIG. 6. In other words, blocks 502 through 508 illustrated in FIG. 5 correspond to means-plus-function blocks 602 through 608 illustrated in FIG. 6.

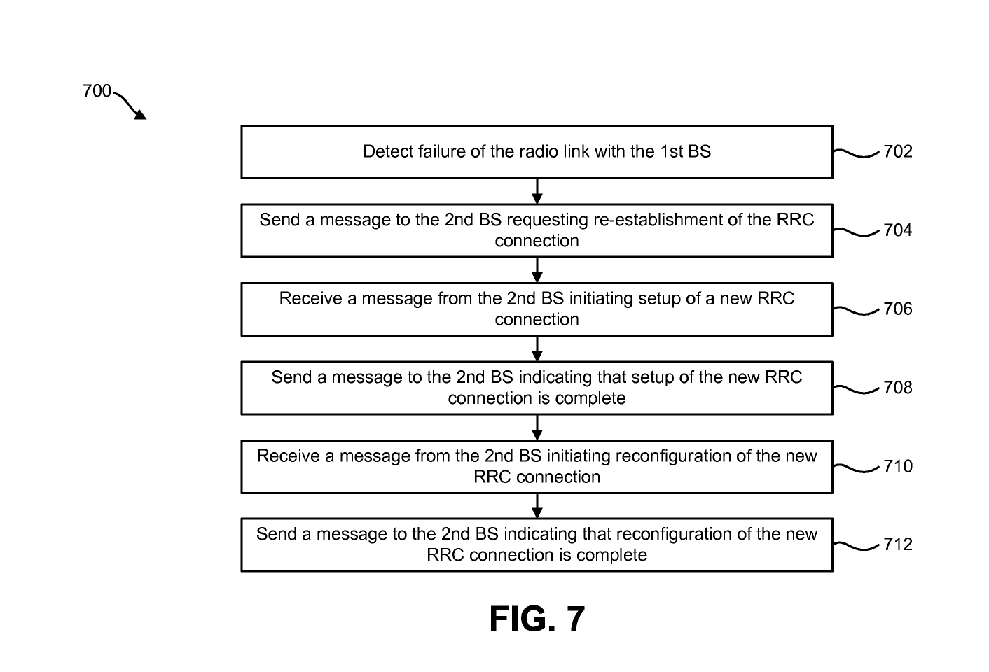

FIG. 7 illustrates another method 700 for re-establishing an RRC connection with a non-prepared base station 204b. The method 700 may be performed by a wireless communication device 206. In this method 700, it will be assumed that the wireless communication device 206 is initially being served by a first base station 204a, and that the wireless communication device 206 has established an RRC connection 214a with the first base station 204a.

At some point, the wireless communication device 206 may detect 702 failure of the radio link with the first base station 204a. This may occur, for example, if the wireless communication device 206 moves outside of the coverage area of the first base station 204a and into the coverage area of a second base station 204b.

In response to detecting 702 failure of the radio link with the first base station 204a, the wireless communication device 206 may send 704 a message to the second base station 204b requesting re-establishment of an RRC connection. As indicated above, the second base station 204b may be a non-prepared base station 204b, i.e., it may not have been prepared with RRC configuration information from the previous serving base station 204a.

The wireless communication device 206 may receive 706 a message from the second base station 204b initiating setup of a new RRC connection 214b. However, unlike the method 300 that was discussed above, in this method 700 the wireless communication device 206 does not release existing radio bearers corresponding to the RRC connection 214a with the first base station 204a. When the setup of the new RRC connection 214b is complete, the wireless communication device 206 may send 708 a message to the second base station 204b indicating that setup of the new RRC connection 214b is complete.

At some point, the wireless communication device 206 may receive 710 a message from the second base station 204b initiating reconfiguration of the new RRC connection 214b. When the reconfiguration of the new RRC connection 214b is complete, the wireless communication device 206 may send 712 a message to the second base station 204b indicating that the reconfiguration of the new RRC connection 214b is complete.

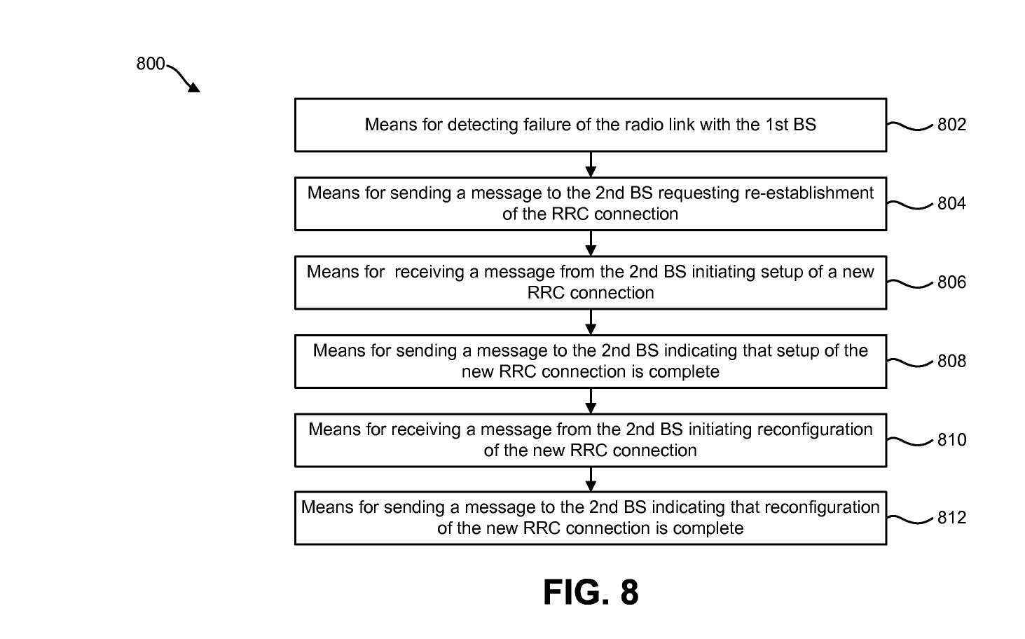

The method 700 of FIG. 7 described above may be performed by various hardware and/or software component(s) and/or module(s) corresponding to the means-plus-function blocks 800 illustrated in FIG. 8. In other words, blocks 702 through 712 illustrated in FIG. 7 correspond to means-plus-function blocks 802 through 812 illustrated in FIG. 8.

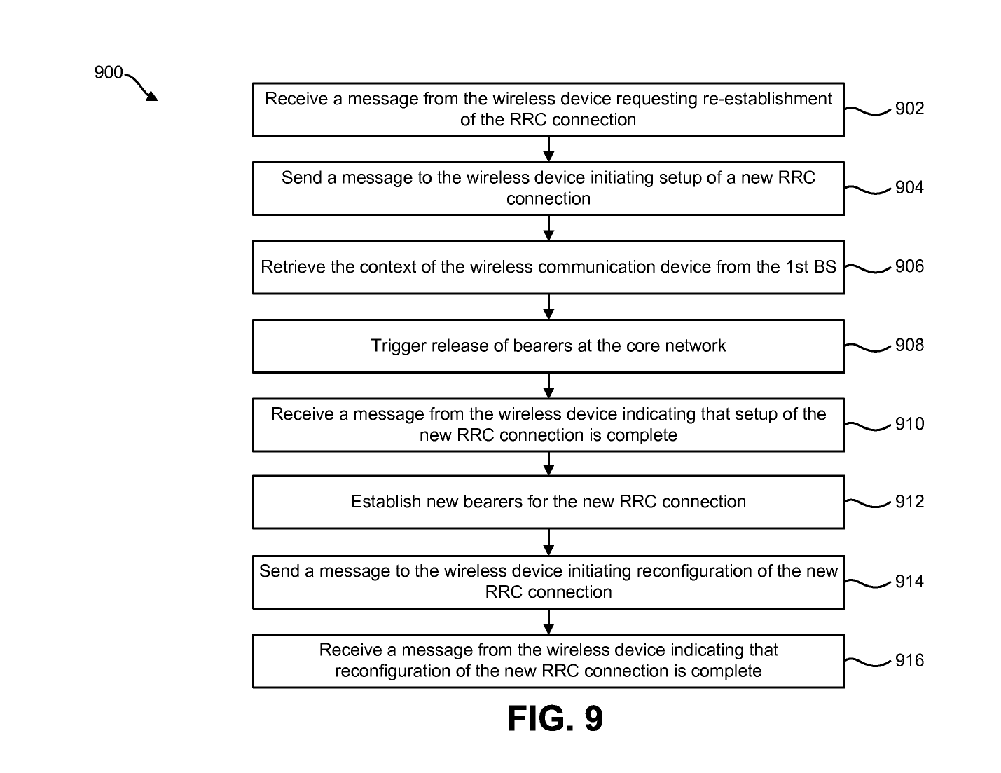

FIG. 9 illustrates a method 900 for facilitating re-establishment of an RRC connection with a non-prepared base station 204b. The method 900 may be performed by a non-prepared base station 204b.

The base station 204b may receive 902 a message from a wireless communication device 206 requesting re-establishment of an RRC connection. In response to receiving 902 this message, the base station 204b may send 904 a message to the wireless communication device 206 initiating setup of a new RRC connection 214b. The base station 204b may retrieve 906 the context (e.g., radio configuration, bearer status, etc.) of the wireless communication device 206 from the first base station 204a. The base station 204b may trigger 908 the release of radio bearers associated with the old RRC connection 214a at the core network. This may involve sending one or more messages to the core network notifying the core network that the radio bearers associated with the old RRC connection 214a should be released. When the setup of the new RRC connection 214b is complete, the base station 204b may receive 910 a message from the wireless communication device 206 indicating that the setup of the new RRC connection 214b is complete.

The base station 204b may establish 912 new radio bearers for the new RRC connection 214b. The base station 204b may send 914 a message to the wireless communication device 206 initiating reconfiguration of the new RRC connection 214b. The base station 204b may receive 916 a message from the wireless communication device 206 indicating that reconfiguration of the new RRC connection 214b is complete.

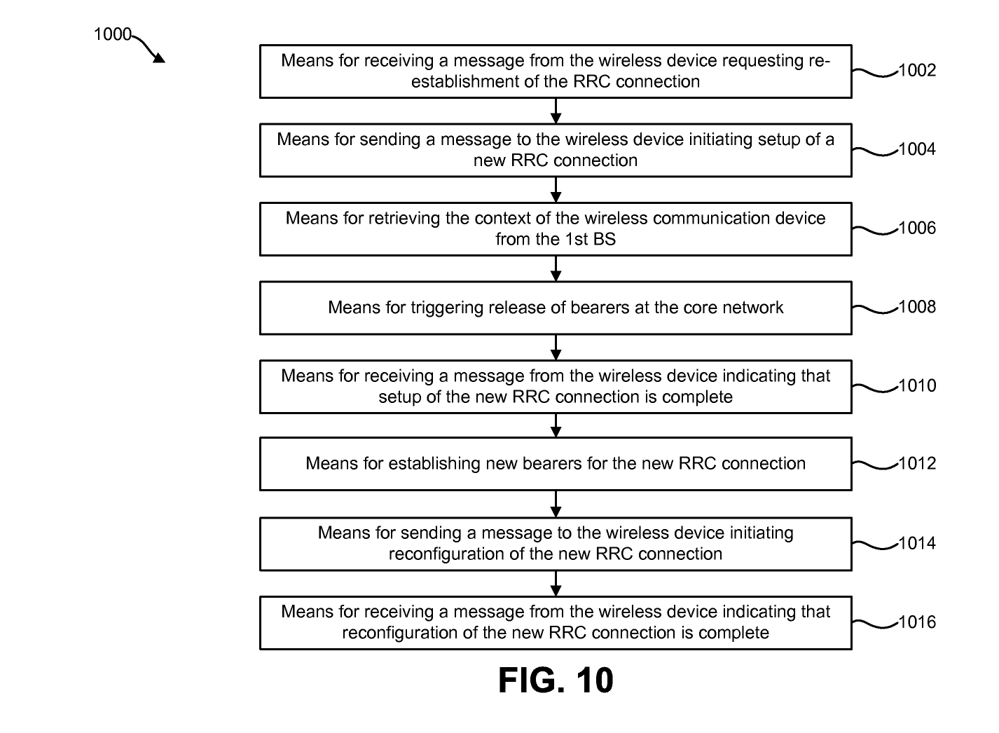

The method 900 of FIG. 9 described above may be performed by various hardware and/or software component(s) and/or module(s) corresponding to the means-plus-function blocks 1000 illustrated in FIG. 10. In other words, blocks 902 through 916 illustrated in FIG. 9 correspond to means-plus-function blocks 1002 through 1016 illustrated in FIG. 10.

There are a number of standards organizations that attempt to develop standards for wireless communication systems. One example of such a standards organization is the 3rd Generation Partnership Project (3GPP). 3GPP LTE (Long Term Evolution) is a set of enhancements to the Universal Mobile Telecommunications System (UMTS). The systems and methods disclosed herein may be utilized in an LTE system. In an LTE system, a wireless communication device may be referred to as user equipment (UE), and a base station may be referred to as an evolved Node B (eNode B or eNB).

A method of maintaining a radio-layer connection in an LTE system when a UE attempts to re-establish a connection with a non-prepared eNB will now be described. When an LTE UE experiences radio link failure, or certain other conditions requiring a “reset” of the RRC connection, the UE transmits an RRCConnectionReestablishmentRequest message to the first eNB that it is able to reach (which may or may not be the previous serving eNB). If the eNB has been “prepared” with RRC configuration information by the previous serving eNB, it responds to the re-establishment request with an RRCConnectionReestablishment message, providing the necessary information for the connection to be reestablished. If the eNB has not been prepared, it sends an RRCConnectionReestablishmentReject message and the UE goes to idle.

This procedure is a special case of so-called forward handover, in which the UE performs mobility by “appearing” in a new serving eNB and triggering its RRC connection to be transferred there from the previous serving eNB. In LTE Release 8, forward handover is included in the LTE specification only for the case of radio link failure. If the UE is fortunate enough to recover from the failure in a cell that is being served by a prepared eNB (including the cell that is being served by the previous serving eNB), the UE can re-establish its connection and continue.

In the more general case of forward handover, the UE could trigger re-establishment in a new cell irrespective of whether the eNB that is serving the new cell is prepared. A non-prepared eNB may have some mechanism to receive the UE's context (e.g., radio configuration, bearer status, etc.) from the previous serving eNB. However, the more general case of forward handover is not currently supported in LTE. Currently in an LTE system, if the UE triggers re-establishment of an RRC connection in a cell that is being served by a non-prepared eNB, then, as indicated above, the non-prepared eNB sends an RRCConnectionReestablishmentReject message and the UE goes to idle. If the UE has reason to remain in connected mode (e.g., uplink data to transmit), it will immediately request a new RRC connection, using the random access procedure (involving messaging on the common control channel (CCCH) and on layer 2 shared resources) for the new request. This procedure is expensive in terms of messaging, particularly because the random access procedure takes place on shared rather than dedicated radio resources.

An alternative procedure will now be described in which the UE is not required to pass through the RRC_IDLE state, and in which the messaging to restore an RRC connection for the UE may be minimized. With this procedure, the non-prepared eNB described above handles the attempted re-establishment of an RRC connection as if it were a connection request.

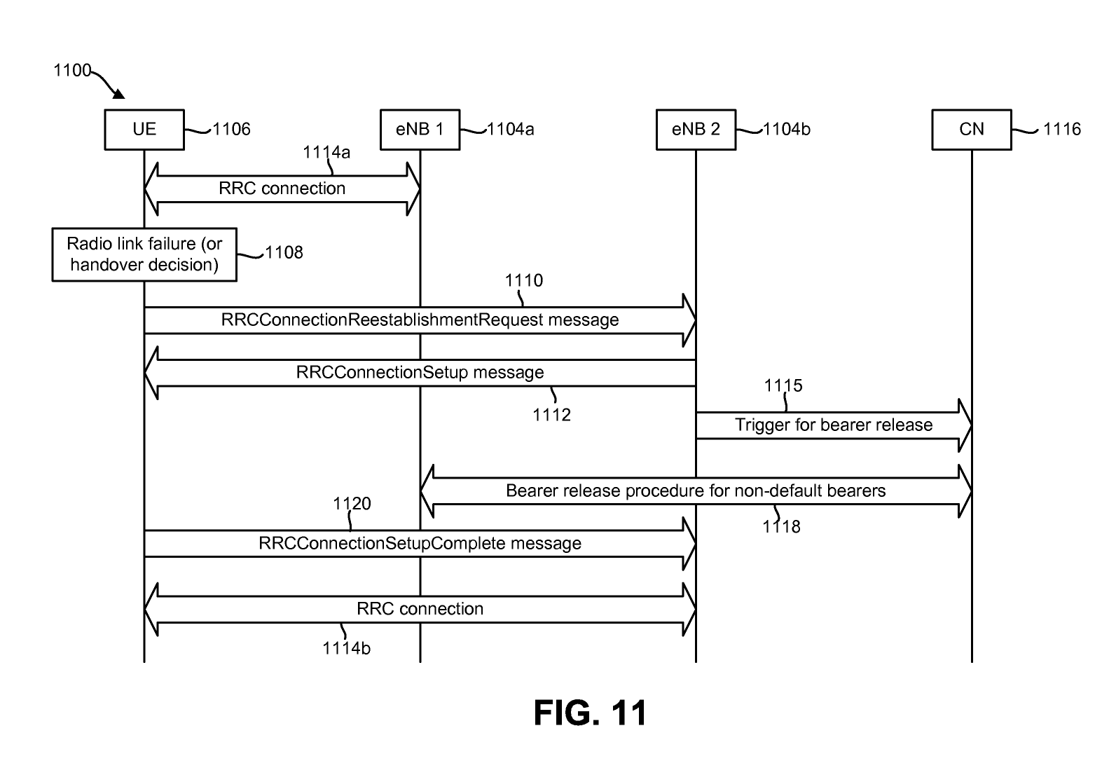

FIG. 11 illustrates a method 1100 for facilitating re-establishment of an RRC connection in an LTE system. The method 1100 involves a UE 1106, a first eNB 1104a, a second eNB 1104b, and a core network 1116.

Initially, it will be assumed that the UE 1106 has an RRC connection 1114a with the first eNB 1104a. The UE 1106 may experience radio link failure 1108. Alternatively, a decision may be made to handover the UE 1106 from the first eNB 1104a to the second eNB 1104b. In response to the radio link failure 1108 (or handover decision), the UE 1106 may send an RRCConnectionReestablishmentRequest message 1110 to the second eNB 1104b. In response to receiving the RRCConnectionReestablishmentRequest message 1110, the second eNB 1104b may send an RRCConnectionSetup message 1112 to the UE 1106.

The second eNB 1104b may send a message 1115 to the core network 1116 triggering a release of the bearers that are associated with the RRC connection 1114a with the first eNB 1104a. In response, the core network 1116 and the first eNB 1104a may participate in a bearer release procedure 1118 for all non-default bearers. When the setup of the RRC connection 1114b is complete, the UE 1106 may send an RRCConnectionSetupComplete message 1120 to the second eNB 1104b.

In the method 1100 of FIG. 11, no attempt is made to maintain continuity of the established bearers. For upper layers the behavior is as if the UE 1106 had gone to idle and established a new connection. From the perspective of the UE's 1106 behavior, the UE expects the RRCConnectionSetup message 1112 as a third potential response to the RRCConnectionReestablishmentRequest message 1110 (the two preexisting potential responses being the RRCConnectionReestablishment and RRCConnectionReestablishmentReject messages). The UE 1106 can determine through receiving this response that it should internally release all data radio bearers (DRBs) and evolved packet system (EPS) bearers (thus achieving synchronization with the network side) and treat the resulting RRC connection 1114b as new. (The EPS bearer provides packet data network (PDN) connectivity service to the UE via EPS access. The DRB is used to transport packets of an EPS bearer between the eNB and the UE, and has a one-to-one relationship with a single EPS bearer.)

Alternatively, the RRCConnectionSetup message 1112 could be replaced by another message, e.g., a new RRC message or a new version of the RRCConnectionReconfiguration message, with the same functionality.

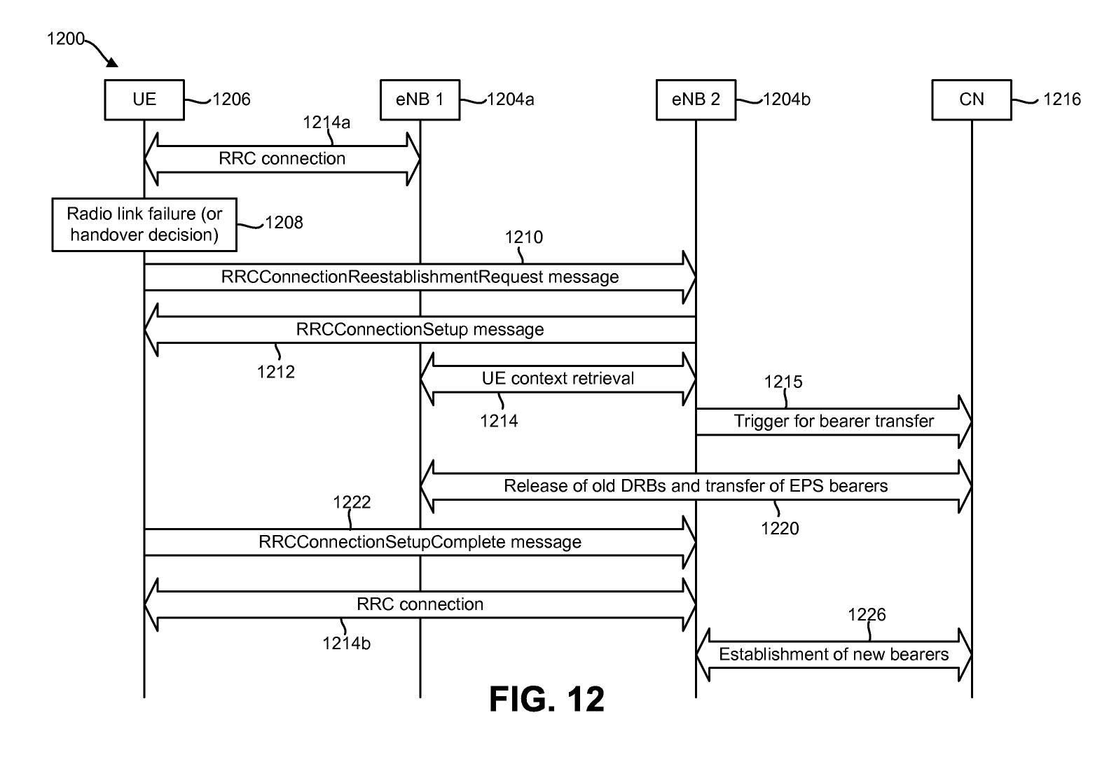

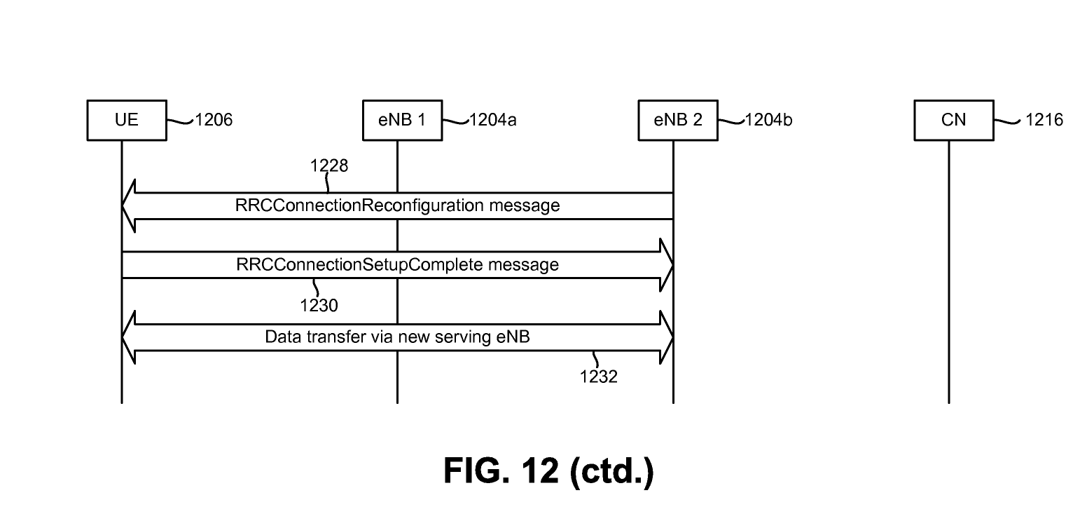

FIG. 12 illustrates another method 1200 for facilitating re-establishment of an RRC connection in an LTE system. The method 1200 involves a UE 1206, a first eNB 1204a, a second eNB 1204b, and a core network 1216.

The method 1200 of FIG. 12 may be thought of as a “half-forward handover”. The network may transfer the context from the source eNB 1204a after (or asynchronously with) the setup of the RRC connection 1214b itself The UE 1206 need not release bearers (except as instructed by the network later, using existing procedures), but the (new) serving eNode B 1204b can bring the UE 1206 to connected mode without waiting for context transfer.

Initially, it will be assumed that the UE 1206 has an RRC connection 1214a with the first eNB 1204a. The UE 1206 may experience radio link failure 1208. Alternatively, a decision may be made to handover the UE 1206 from the first eNB 1204a to the second eNB 1204b. In response to the radio link failure 1208 (or handover decision), the UE 1206 may send an RRCConnectionReestablishmentRequest message 1210 to the second eNB 1204b. In response to receiving the RRCConnectionReestablishmentRequest message 1210, the second eNB 1204b may send an RRCConnectionSetup message 1212 to the UE 1206.

The second eNB 1204b may retrieve the UE's 1206 context from the first eNB 1204a. The second eNB 1204b may send a message 1215 to the core network 1216 indicating a release of the RRC connection 1214a with the first eNB 1204a. In response, the core network 1216 and the first eNB 1204a may participate in a procedure 1220 in which old DRBs are released and EPS bearers are transferred to the new RRC connection 1214b. When the setup of the RRC connection 1214b is complete, the UE 1206 may send an RRCConnectionSetupComplete message 1222 to the second eNB 1204b.

The second eNB 1204b and the core network 1216 may perform an establishment 1226 of new bearers. The second eNB 1204b may send an RRCConnectionReconfiguration message 1228 to the UE 1206. When reconfiguration of the RRC connection 1214b has been completed, the UE 1206 may send an RRCConnectionReconfigurationComplete message 1230 to the second eNB 1204b. Data transfer may then occur 1232 via the new serving eNB 1204b.

In FIG. 12, the establishment 1226 of new bearers (i.e., transfer of EPS bearers and configuration of corresponding DRBs to be established) between the core network 1216 and the second eNB 1204b is shown as taking place immediately after the new RRC connection 1214b is established. However, these steps should be considered as asynchronous. Similarly, the retrieval 1214 of the UE's 1206 context from the first eNB 1204a should be completed before the interactions with the core network 1216 to transfer and establish bearers can begin, but these processes are asynchronous with respect to the RRC messaging between the second eNB 1204b and the UE 1206.

In essence, the method 1200 of FIG. 12 starts with the same RRC messaging as in the method 1100 of FIG. 11, but the interactions within the network are different, and this changed network behavior allows the RRC connection to be transferred.

The methods 1100, 1200 of FIGS. 11 and 12 are not mutually exclusive. A flag in downlink signaling (e.g., in the RRCConnectionSetup message) could indicate to the UE whether to perform a local release of bearers (as in the method 1100 of FIG. 11) or preserve its local bearer state in expectation of a subsequent reconfiguration (as in the method 1200 of FIG. 12). In addition, the UE's request for reestablishment (the RRCConnectionReestablishment message) could include a flag indicating whether the UE requests immediate re-establishment in the event that the eNB is not prepared.

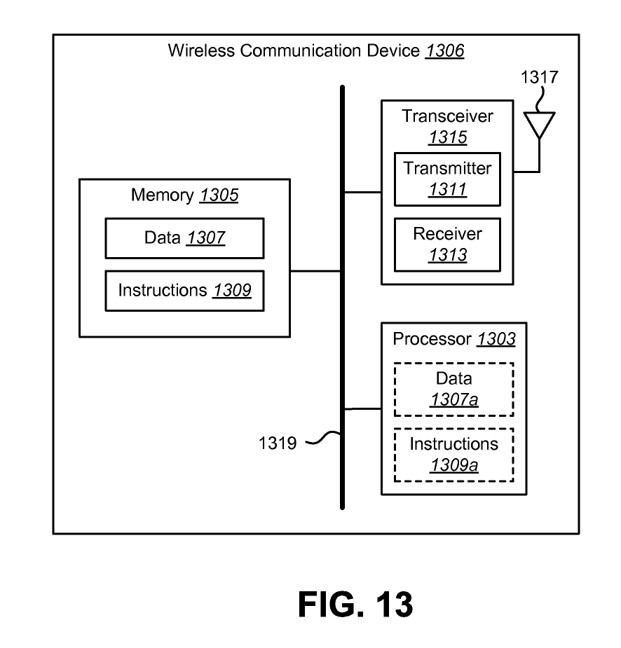

FIG. 13 illustrates certain components that may be included within a wireless communication device 1306. The wireless communication devices 106, 206 and the UEs 1106, 1206 discussed previously may be configured similarly to the wireless communication device 1306 shown in FIG. 13.

The wireless communication device 1306 includes a processor 1303. The processor 1303 may be a general purpose single- or multi-chip microprocessor (e.g., an ARM), a special purpose microprocessor (e.g., a digital signal processor (DSP)), a microcontroller, a programmable gate array, etc. The processor 1303 may be referred to as a central processing unit (CPU). Although just a single processor 1303 is shown in the wireless communication device 1306 of FIG. 13, in an alternative configuration, a combination of processors (e.g., an ARM and DSP) could be used.

The wireless communication device 1306 also includes memory 1305 in electronic communication with the processor 1303 (i.e., the processor 1303 can read information from and/or write information to the memory 1305). The memory 1305 may be any electronic component capable of storing electronic information. The memory 1305 may be embodied as random access memory (RAM), read only memory (ROM), magnetic disk storage media, optical storage media, flash memory devices in RAM, on-board memory included with the processor, programmable read-only memory (PROM), erasable programmable read only memory (EPROM), electrically erasable PROM (EEPROM), registers, and so forth, including combinations thereof

Data 1307 and instructions 1309 may be stored in the memory 1305. The instructions 1309 may include one or more programs, routines, sub-routines, functions, procedures, etc. The instructions 1309 may include a single computer-readable statement or many computer-readable statements. The instructions 1309 may be executable by the processor 1303 to implement the methods disclosed herein. Executing the instructions 1309 may involve the use of the data 1307 that is stored in the memory 1305. FIG. 13 shows some instructions 1309a and data 1307a being loaded into the processor 1303.

The wireless communication device 1306 may also include a transmitter 1311 and a receiver 1313 to allow transmission and reception of signals between the wireless communication device 1306 and a remote location (e.g., a base station). The transmitter 1311 and receiver 1313 may be collectively referred to as a transceiver 1315. An antenna 1317 may be electrically coupled to the transceiver 1315. The wireless communication device 1306 may also include (not shown) multiple transmitters, multiple receivers, multiple transceivers and/or multiple antenna.

The various components of the wireless communication device 1306 may be coupled together by one or more buses, which may include a power bus, a control signal bus, a status signal bus, a data bus, etc. For simplicity, the various buses are illustrated in FIG. 13 as a bus system 1319.

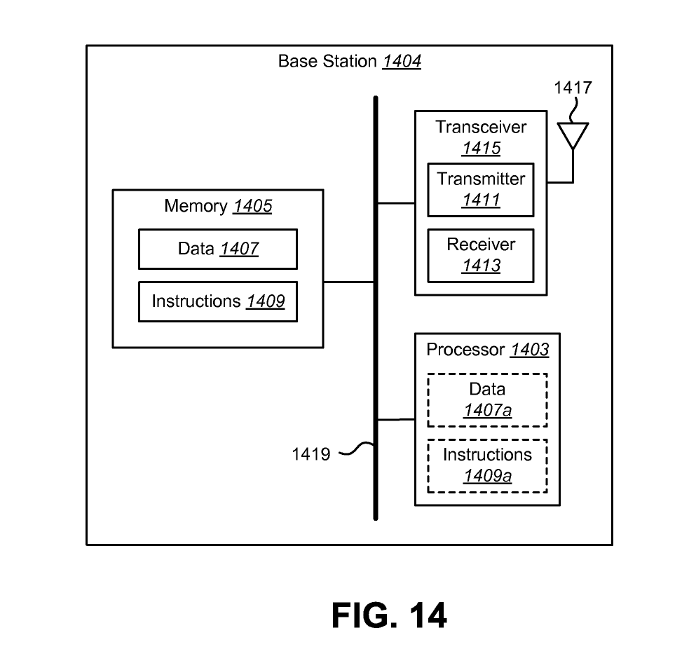

FIG. 14 illustrates certain components that may be included within a base station 1404. The base stations 104, 204a, 204b and the eNBs 1104a, 1104b, 1204a, 1204b discussed previously may be configured similarly to the base station 1404 that is shown in FIG. 14.

The base station 1404 includes a processor 1403. The processor 1403 may be a general purpose single- or multi-chip microprocessor (e.g., an ARM), a special purpose microprocessor (e.g., a digital signal processor (DSP)), a microcontroller, a programmable gate array, etc. The processor 1403 may be referred to as a central processing unit (CPU). Although just a single processor 1403 is shown in the base station 1404 of FIG. 14, in an alternative configuration, a combination of processors (e.g., an ARM and DSP) could be used.

The base station 1404 also includes memory 1405 in electronic communication with the processor 1403 (i.e., the processor 1403 can read information from and/or write information to the memory 1405). The memory 1405 may be any electronic component capable of storing electronic information. The memory 1405 may be embodied as random access memory (RAM), read only memory (ROM), magnetic disk storage media, optical storage media, flash memory devices in RAM, on-board memory included with the processor, programmable read-only memory (PROM), erasable programmable read only memory (EPROM), electrically erasable PROM (EEPROM), registers, and so forth, including combinations thereof.

Data 1407 and instructions 1409 may be stored in the memory 1405. The instructions 1409 may include one or more programs, routines, sub-routines, functions, procedures, etc. The instructions 1409 may include a single computer-readable statement or many computer-readable statements. The instructions 1409 may be executable by the processor 1403 to implement the methods that were described above in connection with the base stations 104, 204a, 204b and the eNBs 1104a, 1104b, 1204a, 1204b. Executing the instructions 1409 may involve the use of the data 1407 that is stored in the memory 1405. FIG. 14 shows some instructions 1409a and data 1407a being loaded into the processor 1403.

The base station 1404 may also include a transmitter 1411 and a receiver 1413 to allow transmission and reception of signals between the base station 1404 and a remote location (e.g., a wireless communication device). The transmitter 1411 and receiver 1413 may be collectively referred to as a transceiver 1415. An antenna 1417 may be electrically coupled to the transceiver 1415. The base station 1404 may also include (not shown) multiple transmitters, multiple receivers, multiple transceivers and/or multiple antenna.

The various components of the base station 1404 may be coupled together by one or more buses, which may include a power bus, a control signal bus, a status signal bus, a data bus, etc. For simplicity, the various buses are illustrated in FIG. 14 as a bus system 1419.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The functions described herein may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for establishing a radio resource control connection, the method being performed by a wireless communication device, the method comprising:
establishing a radio resource control connection with a first base station;
sending a message to a second base station that requests re-establishment of the radio resource control connection; and
receiving a message from the second base station that initiates setup of a new radio resource control connection.

2. The method of claim 1, further comprising releasing existing bearers corresponding to the radio resource control connection in response to receiving the message.

3. The method of claim 1, wherein the wireless communication device does not release existing bearers corresponding to the radio resource control connection in response to receiving the message, and further comprising receiving a message from the second base station that initiates reconfiguration of the new radio resource control connection.

4. The method of claim 1, wherein the message that requests re-establishment of the radio resource control connection is sent to the second base station in response to detecting failure of a radio link with the first base station.

5. The method of claim 1, wherein the message that requests re-establishment of the radio resource control connection is sent to the second base station in response to a decision to handover the wireless communication device from the first base station to the second base station.

6. The method of claim 1, wherein the message that requests re-establishment of the radio resource control connection is an RRCConnectionReestablishmentRequest message, and wherein the message that initiates setup of a new radio resource control connection is an RRCConnectionSetup message.

7. A method for establishing a radio resource control connection, the method being performed by a base station, the method comprising:
receiving a message from a wireless communication device that requests re-establishment of a radio resource control connection; and
sending a message to the wireless communication device that initiates setup of a new radio resource control connection.

8. The method of claim 7, further comprising triggering release of bearers at a core network, wherein the bearers correspond to a radio resource control connection between the wireless communication device and a previous serving base station.

9. The method of claim 7, further comprising establishing new bearers for the new radio resource control connection.

10. The method of claim 7, further comprising retrieving the context of the wireless communication device from a previous serving base station.

11. The method of claim 7, further comprising sending a message to the wireless communication device that initiates reconfiguration of the new radio resource control connection.

12. The method of claim 7, wherein the message that requests re-establishment of the radio resource control connection is an RRCConnectionReestablishmentRequest message, and wherein the message that initiates setup of a new radio resource control connection is an RRCConnectionSetup message.

13. The method of claim 7, wherein the base station is a non-prepared base station that has not received radio resource control configuration information from a previous serving base station.

14. A wireless communication device, comprising:
a processor;
memory in electronic communication with the processor; and
instructions stored in the memory, the instructions being executable by the processor to:
establish a radio resource control connection with a first base station;
send a message to a second base station that requests re-establishment of the radio resource control connection; and
receive a message from the second base station that initiates setup of a new radio resource control connection.

15. The wireless communication device of claim 14, wherein the instructions are also executable to release existing bearers corresponding to the radio resource control connection in response to receiving the message.

16. The wireless communication device of claim 14, wherein the wireless communication device does not release existing bearers corresponding to the radio resource control connection in response to receiving the message, and wherein the instructions are also executable to receive a message from the second base station that initiates reconfiguration of the new radio resource control connection.

17. The wireless communication device of claim 14, wherein the message that requests re-establishment of the radio resource control connection is sent to the second base station in response to detecting failure of a radio link with the first base station.

18. The wireless communication device of claim 14, wherein the message that requests re-establishment of the radio resource control connection is sent to the second base station in response to a decision to handover the wireless communication device from the first base station to the second base station.

19. The wireless communication device of claim 14, wherein the message that requests re-establishment of the radio resource control connection is an RRCConnectionReestablishmentRequest message, and wherein the message that initiates setup of a new radio resource control connection is an RRCConnectionSetup message.

20. A base station, comprising:
a processor;
memory in electronic communication with the processor;
instructions stored in the memory, the instructions being executable by the processor to:
receive a message from a wireless communication device that requests re-establishment of a radio resource control connection; and
send a message to the wireless communication device that initiates setup of a new radio resource control connection.

21. The base station of claim 20, wherein the instructions are also executable to trigger release of bearers at a core network, wherein the bearers correspond to a radio resource control connection between the wireless communication device and a previous serving base station.

22. The base station of claim 20, wherein the instructions are also executable to establish new bearers for the new radio resource control connection.

23. The base station of claim 20, wherein the instructions are also executable to retrieve the context of the wireless communication device from a previous serving base station.

24. The base station of claim 20, wherein the instructions are also executable to send a message to the wireless communication device that initiates reconfiguration of the new radio resource control connection.

25. The base station of claim 20, wherein the message that requests re-establishment of the radio resource control connection is an RRCConnectionReestablishmentRequest message, and wherein the message that initiates setup of a new radio resource control connection is an RRCConnectionSetup message.

26. The base station of claim 20, wherein the base station is a non-prepared base station that has not received radio resource control configuration information from a previous serving base station.

27. A wireless communication device, comprising:
means for establishing a radio resource control connection with a first base station;
means for sending a message to a second base station that requests re-establishment of the radio resource control connection; and
means for receiving a message from the second base station that initiates setup of a new radio resource control connection.

28. The wireless communication device of claim 27, further comprising means for releasing existing bearers corresponding to the radio resource control connection in response to receiving the message.

29. The wireless communication device of claim 27, wherein the wireless communication device does not release existing bearers corresponding to the radio resource control connection in response to receiving the message, and further comprising means for receiving a message from the second base station that initiates reconfiguration of the new radio resource control connection.

30. A base station, comprising:
means for receiving a message from a wireless communication device that requests re-establishment of a radio resource control connection; and
means for sending a message to the wireless communication device that initiates setup of a new radio resource control connection.

31. The base station of claim 30, further comprising means for triggering release of bearers at a core network, wherein the bearers correspond to a radio resource control connection between the wireless communication device and a previous serving base station.

32. The base station of claim 30, further comprising means for establishing new bearers for the new radio resource control connection.

33. The base station of claim 30, further comprising means for retrieving the context of the wireless communication device from a previous serving base station.

34. A computer-program product comprising a computer-readable medium having instructions thereon, the instructions comprising:
code for establishing a radio resource control connection with a first base station;
code for sending a message to a second base station that requests re-establishment of the radio resource control connection; and
code for receiving a message from the second base station that initiates setup of a new radio resource control connection.

35. The computer-program product of claim 34, wherein the instructions further comprise code for releasing existing bearers corresponding to the radio resource control connection in response to receiving the message.

36. The computer-program product of claim 34, wherein the wireless communication device does not release existing bearers corresponding to the radio resource control connection in response to receiving the message, and wherein the instructions further comprise code for receiving a message from the second base station that initiates reconfiguration of the new radio resource control connection.

37. A computer-program product comprising a computer-readable medium having instructions thereon, the instructions comprising:
code for receiving a message from a wireless communication device that requests re-establishment of a radio resource control connection; and
code for sending a message to the wireless communication device that initiates setup of a new radio resource control connection.

38. The computer-program product of claim 37, wherein the instructions further comprise code for triggering release of bearers at a core network, wherein the bearers correspond to a radio resource control connection between the wireless communication device and a previous serving base station.

39. The computer-program product of claim 37, wherein the instructions further comprise code for establishing new bearers for the new radio resource control connection.

40. The computer-program product of claim 37, wherein the instructions further comprise code for retrieving the context of the wireless communication device from a previous serving base station.
